(19) United States
(12) Patent Application Publication
(10) Pub. No.: US 2024/0265478 A1
(43) Pub. Date: Aug. 8, 2024

(54) REAL PROPERTY INSPECTION METHODS AND SYSTEMS

(71) Applicant: 1378713 B.C. LTD., Surrey (CA)

(72) Inventors: Jason LOMBARDO, Montpelier, VT (US); James GARNETT, Surrey (CA); Anna GARNETT, Surrey (CA)

(21) Appl. No.: 18/432,868

(22) Filed: Feb. 5, 2024

Related U.S. Application Data
(60) Provisional application No. 63/483,459, filed on Feb. 6, 2023.

(51) Int. Cl. G06Q 50/163; G06T 7/00; G06V 10/82; G06V 20/70

(52) U.S. Cl. CPC G06Q 50/163; G06T 7/0002; G06V 10/82; G06V 20/70; G06T 2207/20084

(57) ABSTRACT

A method for inspecting a real property unit comprises obtaining inspection particulars. The inspection particulars may comprise property details describing details of the real property unit. The method may also comprise autonomously parsing the property details into an inspection sequence comprising a plurality of sequential machine-readable codes defining a series of images to be acquired. The method may also comprise instructing a user to sequentially acquire a plurality of images based on the generated inspection sequence. The method may also comprise using at least one machine learning model to process the acquired plurality of images to generate a labelled set of images labelling one or more identified objects or characteristics correlating the labeled objects or characteristics to perils to the real property unit. The method may also comprise generating an inspection report for the real property unit based on the violation labels and identified perils.

### CROSS-REFERENCE TO RELATED APPLICATIONS

This application claims priority from U.S. application No. 63/483,459 filed 6 Feb. 2023 and entitled REAL PROPERTY INSPECTION METHODS AND SYSTEMS which is hereby incorporated herein by reference for all purposes. For purposes of the United States of America, this application claims the benefit under 35 U.S.C. § 119 of U.S. application No. 63/483,459 filed 6 Feb. 2023 and entitled REAL PROPERTY INSPECTION METHODS AND SYSTEMS which is hereby incorporated herein by reference for all purposes.

### FIELD

The present disclosure relates to real property inspection methods and systems. Some embodiments provide methods for efficiently inspecting a real property unit.

### BACKGROUND

Real property units such as commercial retail spaces, buildings, houses, apartments and condominiums are regularly leased to tenants (e.g., residential tenants, commercial tenants, etc.). It is undesirable to the owners of such real property units for the real property units to be damaged by tenants who occupy the units. To mitigate a risk of damage, in-person inspections of real property units may be periodically performed at the request of the owners (or property managers or the like) of the real property units. In some cases, owners of real property units are required to perform inspections (e.g., periodically) under their insurance policy. However, such inspections may be invasive for a tenant, may be labor intensive, may be time intensive and/or the like.

There is a need for improved real property inspection methods and systems.

### SUMMARY

This invention has a number of aspects. These include, without limitation:
systems and methods for inspecting real property;
methods for parsing descriptions of real property;
methods for generating a sequence of items to be inspected in a real property unit;
methods for identifying property damage or risk of property damage within acquired images of a real property unit.

One aspect of the invention described herein provides a method for inspecting a real property unit. The method may comprise obtaining inspection particulars. The inspection particulars may comprise property details describing details of the real property unit to be inspected. The method may also comprise autonomously processing the property details to parse the property details into an inspection sequence comprising a plurality of sequential machine-readable codes defining a series of images to be acquired of the real property unit. The method may also comprise instructing a user to sequentially acquire a plurality of images based on the generated inspection sequence. The method may also comprise using at least one machine learning model processing the acquired plurality of images to generate a labelled set of images. The processing may comprise labelling one or more identified objects or characteristics in images of the acquired plurality of images and correlating the labeled objects or characteristics to corresponding violation labels representing perils to the real property unit. The method may also comprise generating an inspection report for the real property unit based on the violation labels of the labelled set of images and identified perils.

In some embodiments, processing the property details to parse the property details into the inspection sequence comprises grouping objects to be inspected within the real property unit with locations of the respective objects within the real property unit.

In some embodiments, the inspection sequence first comprises machine-readable codes associated with objects to be inspected within a first location prior to a machine-readable code encoding a second location to be inspected.

In some embodiments, processing the property details to parse the property details into the inspection sequence comprises generating at least one machine-readable code corresponding to a portion of at least one of the objects to be inspected.

In some embodiments, the plurality of sequential machine-readable codes comprise a plurality of n-character machine-readable codes wherein n is a positive integer. Each of the n-character machine-readable codes may be separated from one another by a separating character.

In some embodiments, the property details are provided by at least one of free-form text description, a photographic image, a video, and a document associated with the real property unit.

In some embodiments, the method comprises verifying that the plurality of images are acquired by the user in response to instructions corresponding to the machine-readable codes of the inspection sequence received by the user.

In some embodiments, verifying that plurality of images are acquired by the user in response to instructions received by the user comprises verifying that the user is using a mobile device and that the plurality of images are acquired with a built-in camera of the mobile device.

In some embodiments, the method comprises instructing a user to vary one or more image capture settings to capture a higher quality image.

In some embodiments, the method comprises instructing a user to acquire an image corresponding to a current machine-readable code of the inspection sequence until an adequate image corresponding to the current machine-readable code is acquired.

In some embodiments, the at least one machine learning model comprises a deep neural network.

In some embodiments, the at least one machine learning model comprises a minimum confidence score of about 50%.

In some embodiments, the at least one machine learning model is constrained to generate a maximum of about 50 labels per image.

In some embodiments, correlating the labeled object to corresponding violation labels comprises discarding labels previously deemed to be irrelevant.

In some embodiments, the method comprises comparing remaining labels against labels previously deemed to be relevant.

In some embodiments, the method comprises ranking relevancy of the labeled objects or characteristics.

In some embodiments, the ranking is based on at least one of a measure of confidence and severity of the identified peril.

In some embodiments, processing the property details to parse the property details into the inspection sequence is performed using a trained machine learning model.

Another aspect of the invention described herein provides a system comprising a server. The server may be configured to perform a method having any feature described herein. The server may be configured to interact with one or more of an owner device, a tenant device, an operator device and a reviewer device.

Another aspect of the invention described herein provides a method for inspecting a real property unit. The method may comprise obtaining inspection particulars. The inspection particulars may comprising property details describing details of the real property unit to be inspected. The method may also comprise autonomously processing the property details to parse the property details into an inspection sequence comprising a plurality of sequential machine-readable codes defining a series of images to be acquired of the real property unit. The processing may be performed on a server. The method may also comprise transmitting the machine-readable codes from the server to a user device. The method may also comprise instructing a user to sequentially acquire with a camera of the user device a plurality of images based on the transmitted machine-readable codes. The method may also comprise transmitting the acquired plurality of images from the user device to the server. The method may also comprise using at least one machine learning model processing on the server the acquired plurality of images to generate a labelled set of images. The processing may comprise labelling one or more identified objects or characteristics in images of the acquired plurality of images and correlating the labeled objects or characteristics to corresponding violation labels representing perils to the real property unit. The method may also comprise generating an inspection report for the real property unit based on the violation labels of the labelled set of images and identified perils.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1 is a flow chart of a method for inspecting real property according to an example embodiment of the invention described herein.

FIG. 2 is a schematic block diagram of a system for inspecting real property according to an example embodiment of the invention described herein.

FIG. 3 is a schematic block diagram of an inspection sequence for inspecting real property according to an example embodiment of the invention described herein.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

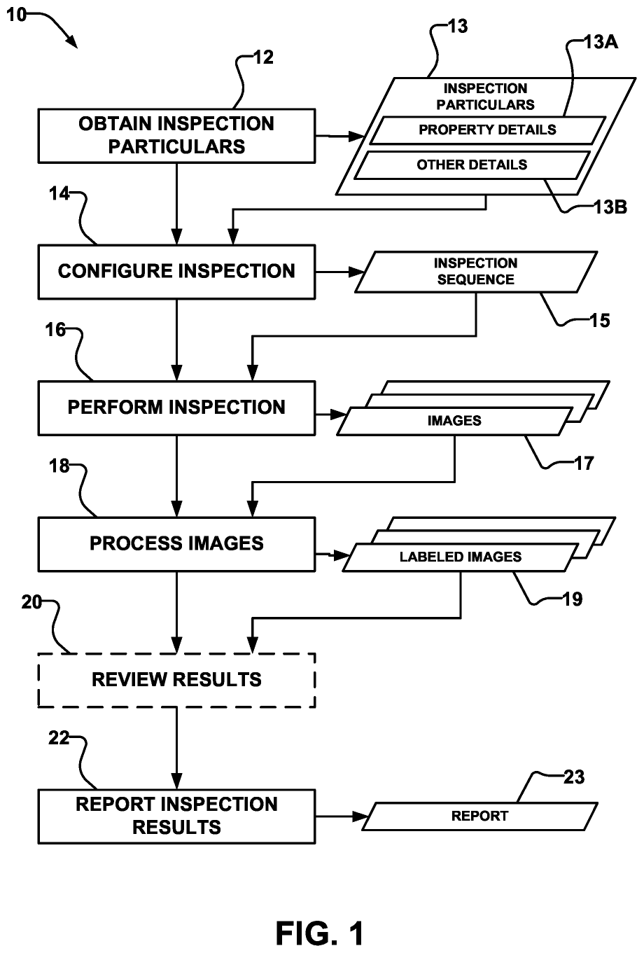

FIG. 1 is a flowchart which illustrates an example method 10 for inspecting property. Method 10 may for example, be performed to inspect property such as tenanted real property units.

At block 12, inspection particulars 13 are obtained. Inspection particulars 13 may for example, be obtained from an owner of a real property unit, a property manager of a real property unit, a rental housing provider and/or a database containing particulars of many real property units (e.g., a municipal database or the like). Inspection particulars 13 define parameters of an inspection to be performed. Inspection particulars 13 comprise property details 13A. Property details 13A comprise particulars such as a layout of a real property unit to be inspected, specific regions of a real property unit to be inspected, specific things or objects (e.g., appliances, furniture, etc.) to be inspected within a real property unit, etc. Property details 13A may for example, be provided by (non-limiting):
free-form text description;
uploading one or more photographic images;
uploading one or more videos;
uploading one or more documents (e.g., floor plans, property records, etc.);
a combination of two or more of the above;
etc.

Additionally, or alternatively, inspection particulars may comprise other details 13B such as (non-limiting):
information about the owner of the real property unit, the property manager of the real property unit or the rental housing provider (e.g., name, contact information, etc.) commissioning an inspection;
a date on which or by which the inspection of the real property unit is to be completed;
information about a tenant (or tenants) that occupy the property to be inspected (e.g., name(s), contact information, etc.);
etc.

At block 14, inspection instructions for a residential property unit are configured based on provided inspection particulars 13. Configuring inspection instructions may comprise converting provided property details 13A into a machine-readable inspection sequence 15 which encodes step-by-step instructions for completing a desired inspection of a real property unit. In some embodiments, provided property details 13A are scanned and parsed into sequential steps. In some embodiments, a machine learning model is trained to process property details 13A and generate inspection sequence 15 therefrom. Inspection sequence 15 may include steps to inspect one or more locations 15A (e.g., rooms, floors, areas, etc.), one or more things or objects 15B (e.g., appliances or infrastructure such as hot water heaters, toilets, furnaces, furniture, etc.) within one or more of the locations 15A and/or one or more portions or features 15C (e.g., a shower door, a toilet seat, a cabinet handle, etc.) of one or more of the objects 15B.

Each step may be represented by a machine-readable code. Each machine-readable code may comprise, for example, an n-character code, where n is a positive integer. In some embodiments, each machine-readable code comprises a four character code. Individual machine-readable codes may be separated by a separating character (e.g., a ‘+’ character). For example, if the provided property details 13A comprise the word “kitchen”, a photo of a kitchen, a video of a kitchen, etc., then block 14 may add a machine-readable code such as “KITC” to machine-readable inspection sequence 15 encoding that a real property unit to be inspected comprises a kitchen that is to be inspected. As another example, if the provided property particulars 13 comprise the words “living room”, “main saloon”, etc. (or a photo of a living room and/or the like), then, at block 14, a machine-readable code such as “LIVR” may be added to machine-readable inspection sequence 15 encoding that a real property unit to be inspected comprises a living room that is to be inspected.

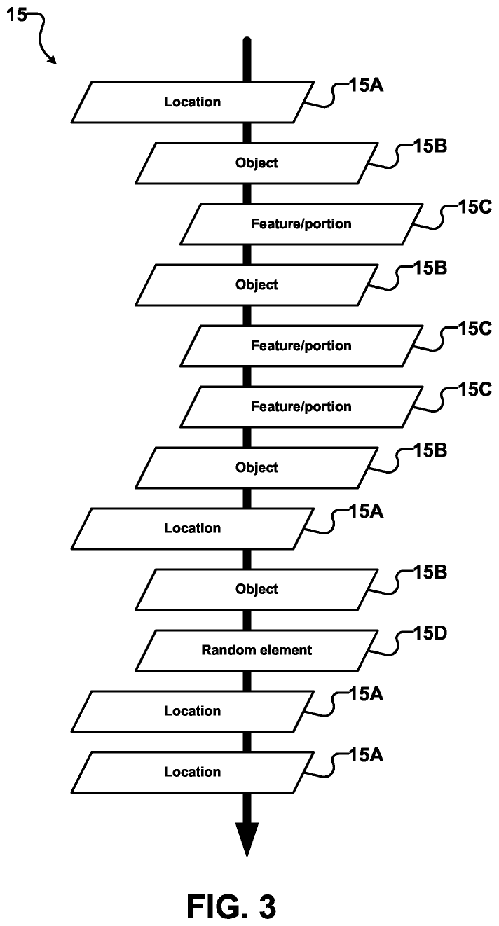

Inspection sequence 15 may organize locations 15A, objects 15B and features 15C in a hierarchical way. For example, FIG. 3 schematically depicts an exemplary inspection sequence 15 comprising a plurality of locations 15A, objects 15B and features 15C organized hierarchically.

In some embodiments, inspection sequence 15 may group objects 15B to be inspected together with locations 15A where those objects 15B are located. In some embodiments, at block 14, a location attribute is assigned to each object 15B. The location attribute may relate the object 15B to a location 15A where the object 15B is located within a real property unit. This may be accomplished by listing corresponding n-character codes for all objects 15B to be inspected in a location 15A after the n-character code for that location 15A such that all objects 15B represented by object codes are understood to be located in the location 15A represented by the preceding n-character location code.

For example, a fridge may be assigned a location attribute encoding that the fridge is located in the kitchen, etc. Machine-readable inspection sequence 15 may therefore comprise a sub-sequence such as “KITC+FRIG”. As another example, if an oven and fridge are to be inspected in the kitchen, then machine-readable inspection sequence 15 may comprise a sub-sequence such as “KITC+FRIG+OVEN” encoding that a kitchen is to be inspected followed by a fridge and an oven in the kitchen.

In some embodiments, inspection sequence 15 starts with a first location 15A, followed by an inspection of all objects 15B-1 in that first location 15A before proceeding to inspect a second location 15A. All of the objects 15B associated with the second location 15A are then inspected before proceeding to a third location 15A (if applicable) and so on, as shown in FIG. 3. In some embodiments, the order of locations 15A of inspection sequence 15 is selected based on proximity of locations 15A to one another. For example, in some embodiments, the closest location 15A that has not yet been inspected is chosen as a next location 15A in sequence 15. In other embodiments, the sequence of locations 15A of inspection sequence 15 is chosen to minimize the distance travelled to follow inspection sequence 15. In some embodiments, inspection sequence 15 is configured such that higher risk locations 15A (e.g., bathrooms, kitchens and the like) are inspected prior to lower risk locations 15A (e.g., bedrooms, dens, dining rooms and the like).

In some embodiments, block 14 assigns additional attributes to objects 15B by encoding that one or more specific portions or features 15C of an object 15B are to be inspected in further detail. For example, if a shower is to be inspected, block 14 may assign an attribute to the shower which encodes that a shower door of the shower is to be inspected in further detail (e.g., to assess for broken glass, etc.). In some such embodiments, block 14 assigns an attribute to the shower at block 14 which encodes that both an inside and an outside of the shower door is to be inspected or that only an inspection of a single side of the shower door is sufficient.

Inspection sequence 15 may therefore be organized in a hierarchical manner such that inspection sequence starts by listing an n-character code for a first location 15A, followed by an n-character code for a first object 15B in the first location 15A followed by n-character codes for any specific features 15C of the first object 15B. Inspection sequence 15 may then continue with an n-character code for a second object 15B in the first location 15A (if applicable) and any specific features 15C of the second object 15B. This may continue until all objects 15B in the first location 15A have been listed. Inspection sequence 15 may then continue with an n-character code for a second location 15A in the same manner until all locations 15A and all objects 15B therein (and all features 15C thereof) have been listed.

As an example case, an inspection sequence 15 for a one bedroom one bathroom real property unit may comprise the following set of machine-readable codes: LIVR+KITC+FRIG+SINK+STOV+OVEN+BATH+SINK+SHOW+BEDR+CLOS. Such inspection sequence 15 represents an inspection which commences with the living room, then the kitchen, then the fridge in the kitchen, then the sink in the kitchen, then the stove in the kitchen, then the oven in the kitchen, then the bathroom, then the sink in the bathroom, then the shower in the bathroom, then the bedroom, then the closet in the bedroom.

In some embodiments, block 14 adds at least one random element 15D to inspection sequence 15 to verify that inspection sequence 15 is performed in real time and/or to mitigate a risk that old images (i.e., previously acquired images (e.g., to hide any damage, etc.)) are being used. For example, block 14 may add a random element 15D to inspection sequence 15. The random element 15D may be associated with a location 15A such that inspection sequence 15 provides instructions to photograph random element 15D in location 15A. Random element 15D may comprise a random object (e.g., a wine bottle, tooth brush, etc.). Location 15A associated with random element 15D may be chosen at random. In some embodiments, the random object and random location are not commonly associated with one another.

In some embodiments, block 14 incorporates existing inspection sequences 15 for one unit into an inspection sequence 15 for one or more other units. Incorporating existing inspection sequences 15 into inspections sequences 15 for other units may improve computational efficiency, reduce required computational resources, etc. For example, an inspection sequence 15 for a 1 bedroom, 1 bathroom unit comprising LIVR+KITC+FRIG+SINK+STOV+OVEN+BATH+SINK+SHOW+BEDR+CLOS may be incorporated into various other inspection sequences 15 as follows:
2 bedroom, 1 bathroom—LIVR+KITC+FRIG+SINK+STOV+OVEN+BATH+SINK+SHOW+BEDR+CLOS+BEDR+CLOS (i.e., this sequence represents the 1 bedroom 1 bathroom sequence and then the additional bedroom and the additional closet in the bedroom);
3 bedroom, 2 bathroom—LIVR+KITC+FRIG+SINK+STOV+OVEN+BATH+SINK+SHOW+BEDR+CLOS+BEDR+CLOS+BEDR+CLOS+BATH+SINK+SHOW+BTUB (i.e., this sequence represents the 2 bedroom 1 bathroom sequence and then the additional bedroom and closet followed by the additional bathroom and the sink, shower and bathtub in the additional bathroom);
1 bedroom, 1 bathroom with a deck—LIVR+KITC+FRIG+SINK+STOV+OVEN+BATH+SINK+SHOW+BEDR+CLOS+DECK (i.e., this sequence represents the 1 bedroom 1 bathroom sequence and then the deck);
1 bedroom, 1 bathroom with a garage and shed—LIVR+KITC+FRIG+SINK +STOV+OVEN+BATH+SINK+SHOW+BEDR+CLOS+GARG+SHED (i.e., the 1 bedroom 1 bathroom sequence and then the garage followed by the shed).

An inspection sequence 15 may comprise a header (or other element(s)) which associates an inspection sequence 15 with a specific real property unit to be inspected, a specific inspection that has been requested and/or the like.

In some embodiments, inspection sequence 15 is stored in a data store as a string.

At block 16, an inspection of a real property unit is performed. A tenant of the real property unit may be guided (or instructed) to acquire one or more images 17 (e.g. still images or frames of video) of the real property unit based on inspection sequence 15. In some embodiments, a tenant may select a preferred language. The user may then be guided to capture one or more images of the real property unit based on the machine-readable codes of inspection sequence 15. At block 16, the machine-readable inspection sequence 15 may be translated into language or prompts that are more readily understandable by a user. For example, LIVR+KITC+FRIG+SINK+STOV+OVEN+BATH+SINK+SHOW+BEDR+CLOS may be translated to:
“Please take a photo of the living room as a whole. Please take a photo of the kitchen as a whole. Please take a photo of the fridge in the kitchen. Please take a photo of the sink in the kitchen. Please take a photo of the stove in the kitchen. Please take a photo of the oven in the kitchen. Please take a photo of the bathroom as a whole. Please take a photo of the sink in the bathroom, please take a photo of the shower in the bathroom. Please take a photo of the bedroom as a whole. Please take a photo of the closet as a whole.”
   In some embodiments, each step is provided separately (e.g., on a new prompt once the preceding step has been accomplished.

The tenant may use a portable computing device (or mobile device) having a camera such as a smartphone or tablet to accomplish each step. For example, if inspection sequence 15 comprises a sequence of LIVR+KITC+BATH, the tenant may be instructed at block 16 to capture an image of the living room followed by an image of the kitchen followed by an image of the bathroom.

In some embodiments, a series of instructions explaining specific images to be acquired based on an inspection sequence 15 are sequentially pushed to a user's portable computing device from a main server (or the like).

In some embodiments, block 16 may not progress to the next code in an inspection sequence 15 until an adequate image for the current code is captured. In some embodiments, block 16 may guide or instruct a tenant how to adjust the device they are using to capture a desired image (e.g., in which direction to move the device, how to increase focus, how to increase lighting, etc.) or a higher quality image.

In some embodiments, block 16 may provide instructions to the tenant which are specific to a current image to be acquired according to inspection sequence 15. For example, block 16 may provide a specific orientation of a kitchen that is to be captured (e.g., the tenant may be instructed to take the photo from the north-west corner of the kitchen). As another example, block 16 may provide a specific region of a bathtub (e.g., a faucet and drain portion) that is to be captured. The specific instructions may be encoded within a code for a specific location and/to be inspected, may be retrievable from a data store based on the code for a specific location and/to be inspected, etc.

In some embodiments, a tenant receives a notification which includes a link or the like to access an inspection relating to a specific inspection sequence 15. In some embodiments, the notification is sent at a pre-scheduled inspection time.

In some embodiments, block 16 verifies that photos are captured in real-time by requiring one or more of:
photos are captured using a compliant mobile device (e.g., block 16 may verify that uploaded photos are being captured using a compliant mobile device and if not, block 16 may prevent the inspection from proceeding until a compliant mobile device is used. In some embodiments, block 16 verifies that a compliant mobile device is being used by verifying that the device being used comprises a required component such as a touchscreen. For example, a window may be checked in JavaScript to determine whether the window includes an ‘ontouchstart’ event. The ‘ontouchstart’ event is only supported on mobile devices with touchscreens and therefore the presence of a touchscreen may be verified based on the presence or absence of the ‘ontouchstart’ event.);
verifying that images (or video as the case may be) are captured using a mobile device's built in camera module;
comparing a time-stamp of a captured image (or video as the case may be) to an upload time;
comparing a geo-location of a captured image (or video as the case may be) to a known location of the real property unit being inspected;
etc.

Captured images 17 (e.g. still images or frames of video) are processed at block 18. Processing captured images 17 may comprise identifying risks of property damage or perils which are present in the specific real property unit. In some embodiments, block 18 uses at least one machine learning model to process images 17. The at least one machine learning model may scan, resize and/or label images 17 to generate a set of labeled images 19. For example, the at least one machine learning model may receive as input images 17 and output as output one or more labelled images 19 wherein each label represents an object, condition, feature, characteristic and/or the like identified within the image 19. In some embodiments, the at least one machine learning model may comprise one or more deep neural networks trained to recognize objects, conditions, features, characteristics and/or the like within images.

The at least one machine learning model may process images 17 on an image-by-image basis. In some embodiments, the at least one machine learning model has a minimum confidence score of about 50%. In some embodiments, the at least one machine learning model has a maximum number of labels to be generated for each image set to about 50.

The at least one machine learning model may comprise an object recognition service provided by a public cloud provider. However, this is not necessary in all cases.

Block 18 may compare labels that are generated for an image 17 and discard labels which have been previously deemed as irrelevant for the purposes of performing a property risk assessment. For example, if labels such as art, automobile, banister, boardwalk, brick, chair, curtain, deck, desk, grille, hardware, island, marble, patio, paper, pillow, ping pong, shelf, shelter, sphere, television, tub, window, zipper, etc. are generated, such labels may be deemed irrelevant and removed as these labels are currently considered to be irrelevant for performing a property risk assessment.

Labels that are not deemed to be irrelevant may be compared against a list of labels that have been previously determined to be relevant potential risks. If a match is found, a corresponding violation label may be added to the image. Adding a violation label may for example, facilitate flagging the image when results of an inspection are reported. For example, the following non-limiting list of labels may be correlated with the corresponding violation labels:
hole, rubble, earthquake, patchwork, ruins, etc. may be matched with a “violation—damage” label;
trash, garbage, pile, etc. may be matched with a “violation—clutter” label;
ant, bat, cockroach, fly, spider, etc. may be matched with a “violation—pests” label;
mud, dirt, fungus, mold, pollution, etc. may be matched with a “violation—filth” label;
burn, smoke, flame, etc. may be matched with a “violation—fire” label;
oil spill, stain, water, rot, liquid may be matched with a “violation-fluid” label.

In some embodiments, relevancy of the labels is ranked. For example, relevancy of the labels may be ranked based on a measure of confidence, severity of a potential risk associated with a corresponding label, etc.

In some embodiments, determining relevancy of the labels is performed by a different machine learning model than the machine learning model which performed the initial labelling. In some embodiments, the same machine learning model performs the initial labelling and determines relevancy of the labels.

The machine learning model which determines relevancy of the labels may be continuously trained to better determine relevancy of labels, generate new violation labels, remove irrelevant violation labels and/or the like.

At optional block 20, labelled images 19 are optionally reviewed by a human to verify correctness of the labels. In some embodiments, a human reviewer may add or remove labels accordingly.

A report 23 may be generated and provided to the owner of the real property unit or the rental housing provider who commissioned the inspection at block 22 based on labelled images 19. Block 22 may for example, quickly sort through labelled images 19 to collect only a subset of images 19 which contain violation labels. The collected subset of images may be included in report 23 alone, together with a generated textual summary of any violations and/or the like. Report 23 may be provided electronically to the owner of the real property unit or the rental housing provider. In some embodiments, report 23 is encrypted, password protected and/or the like.

In some embodiments, one or more blocks of method 10 comprise displaying information and/or data on at least one display. For example, block 12 may comprise displaying one or more prompts intended to at least partially assist with collection of inspection particulars 13. As another example, block 16 may comprise displaying one or more prompts intended to at partially guide performance of an inspection of a real property unit. As another example, block 20 may comprise displaying one or more of labelled images 19. As another example, block 22 may comprise displaying report 23. Different blocks of method 10 may for example, display information and/or data on different displays.

In some embodiments, method 10 comprises providing assistance to a user to carry on with performance of method 10. For example, a user may activate an assistance sub-process (e.g., by pressing a “help” button) where the user may be provided with information to assist them with an encountered problem or challenge. In some embodiments, providing assistance to a user comprises a real-time chat with a customer service representative, display of further information and/or the like.

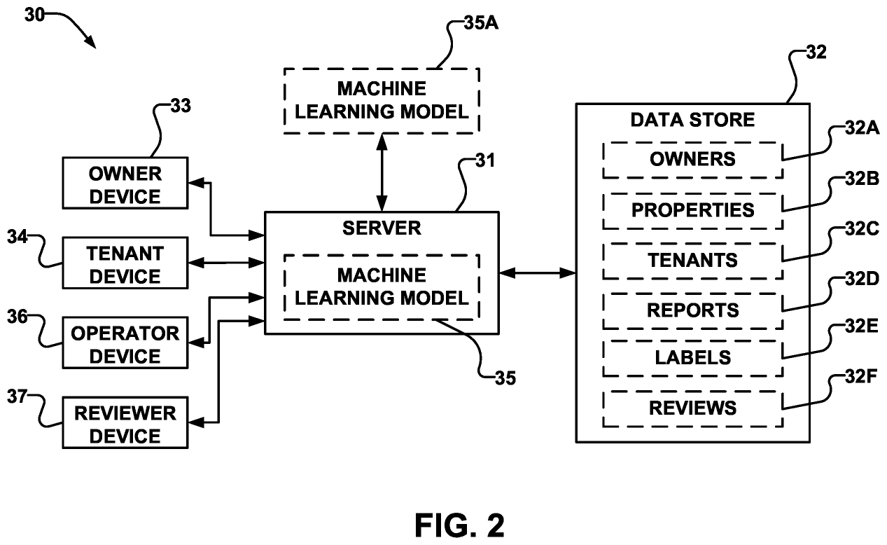

FIG. 2 is a schematic block diagram of an example system 30 for performing inspections of real property units. In some embodiments, system 30 is configured to perform method 10 described herein.

System 30 comprises a server 31 and a data store 32. One or more owner devices 33 are in communication with server 31 to, for example, request an inspection of a real property unit, receive a report of a completed inspection of a real property unit, etc. Server 31 may for example, maintain a record 32A of real property unit owners, a record 32B of inspected properties, a record 32C of tenants, a record 32D of inspection reports and/or the like in data store 32. Maintaining records 32A, 32B, 32C and/or 32D may at least partially facilitate expediting obtaining inspection particulars (e.g., inspection particulars 13) by retrieving such records from data store 32 and auto-populating inspection particulars with the information obtained from records 32A, 32B, 32C and/or 32D.

In some embodiments, data store 32 stores a record of inspections (e.g., inspections to be completed, inspections that are in progress, inspections that have been completed and/or the like). Each inspection may record a subset of data (e.g., owner particulars, property particulars, tenant particulars, inspection particulars and/or the like) corresponding to that inspection.

Server 31 is also in communication with one or more tenant devices 34. Server 31 may for example, retrieve an inspection sequence 15 from data store 32 and communicate specific instructions to a tenant device 34 for a tenant to perform a desired inspection based on the retrieved inspection sequence 15.

In some embodiments, server 31 comprises at least one machine learning model 35 trained to process and label acquired inspection images as described elsewhere herein. Additionally, or alternatively, server 31 may be in communication with at least one machine learning model 35A that is trained to process and label acquired inspection images as described elsewhere herein. One or both of machine learning model 35 and machine learning model 35A may be hosted on a remote cloud server. In some embodiments, data store 32 may comprise a record 32E storing image labels, information relating image labels and potential violations and/or the like.

One or more system operator devices 36 may be in communication with server 31. An operator of system 30 may communicate with server 31 via a device 36 to, for example, adjust labelling of inspection images, schedule an inspection, cancel an inspection, verify accuracy of inspection reports, manage multiple inspections at a property, etc.

As described elsewhere herein, labelled images (e.g., labelled images 19) may optionally be reviewed. Reviewers may for example, be in communication with server 31 via one or more reviewer devices 37. In some cases, reviewers connect to server 31 on an as-needed ad-hoc basis. For example, a reviewer may connect to server 31 to perform an inspection and disconnect once the inspection is completed. A record 32F stored in data store 32 may keep track of reviews completed by a reviewer (e.g., for compensation purposes, etc.).

One or more of owner device(s) 33, tenant device(s) 34, operator device(s) 36 and reviewer device (s) 37 may comprise at least one display.

Where a component (e.g., a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments, the numerical value is 10;
in some embodiments, the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments, the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method for inspecting a real property unit, the method comprising:
obtaining inspection particulars, the inspection particulars comprising property details describing details of the real property unit to be inspected;
autonomously processing the property details to parse the property details into an inspection sequence comprising a plurality of sequential machine-readable codes defining a series of images to be acquired of the real property unit;
instructing a user to sequentially acquire a plurality of images based on the generated inspection sequence;
using at least one machine learning model, processing the acquired plurality of images to generate a labelled set of images, the processing comprising labelling one or more identified objects or characteristics in the acquired plurality of images and correlating the labeled objects or characteristics to corresponding violation labels representing perils to the real property unit; and
generating an inspection report for the real property unit based on the violation labels of the labelled set of images and identified perils.

2. The method of claim 1 wherein processing the property details to parse the property details into the inspection sequence comprises grouping objects to be inspected within the real property unit with locations of the respective objects within the real property unit.

3. The method of claim 2 wherein the inspection sequence first comprises machine-readable codes associated with objects to be inspected within a first location prior to a machine-readable code encoding a second location to be inspected.

4. The method of claim 2 wherein processing the property details to parse the property details into the inspection sequence comprises generating at least one machine-readable code corresponding to a portion of at least one of the objects to be inspected.

5. The method of claim 1 wherein the plurality of sequential machine-readable codes comprise a plurality of n-character machine-readable codes, wherein n is a positive integer and each of the n-character machine-readable codes are separated from one another by a separating character.

6. The method of claim 1 wherein the property details are provided by at least one of free-form text description, a photographic image, a video and a document associated with the real property unit.

7. The method of claim 1 comprising verifying that the plurality of images are acquired by the user in response to instructions corresponding to the machine-readable codes of the inspection sequence received by the user.

8. The method of claim 7 wherein verifying that the plurality of images are acquired by the user in response to instructions received by the user comprises verifying that the user is using a mobile device and that the plurality of images are acquired with a built-in camera of the mobile device.

9. The method of claim 1 comprising instructing a user to vary one or more image capture settings to capture a higher quality image.

10. The method of claim 1 comprising instructing a user to acquire an image corresponding to a current machine-readable code of the inspection sequence until an adequate image corresponding to the current machine-readable code is acquired.

11. The method of claim 1 wherein the at least one machine learning model comprises a deep neural network.

12. The method of claim 1 wherein the at least one machine learning model comprises a minimum confidence score of about 50%.

13. The method of claim 1 wherein the at least one machine learning model is constrained to generate a maximum of 50 labels per image.

14. The method of claim 1 wherein correlating the labeled object to corresponding violation labels comprises discarding labels previously deemed to be irrelevant.

15. The method of claim 14 comprising comparing remaining labels against labels previously deemed to be relevant.

16. The method of claim 1 comprising ranking relevancy of the labeled objects or characteristics.

17. The method of claim 16 wherein the ranking is based on at least one of a measure of confidence and severity of the identified peril.

18. The method of claim 1 wherein processing the property details to parse the property details into the inspection sequence is performed using a trained machine learning model.

19. A system comprising a server, the server configured to perform the method of claim 1, the server configured to interact with one or more of an owner device, a tenant device, an operator device and a reviewer device.

20. A method for inspecting a real property unit, the method comprising:
obtaining inspection particulars, the inspection particulars comprising property details describing details of the real property unit to be inspected;
autonomously processing the property details to parse the property details into an inspection sequence comprising a plurality of sequential machine-readable codes defining a series of images to be acquired of the real property unit, the processing performed on a server;
transmitting the machine-readable codes from the server to a user device;
instructing a user to sequentially acquire with a camera of the user device a plurality of images based on the transmitted machine-readable codes;
transmitting the acquired plurality of images from the user device to the server;
using at least one machine learning model processing on the server the acquired plurality of images to generate a labelled set of images, the processing comprising labelling one or more identified objects or characteristics in the acquired plurality of images and correlating the labeled objects or characteristics to corresponding violation labels representing perils to the real property unit; and
generating an inspection report for the real property unit based on the violation labels of the labelled set of images and identified perils.
